(19) United States
(12) Patent Application Publication
(10) Pub. No.: US 2026/0194201 A1
(43) Pub. Date: Jul. 9, 2026

(54) LIGHTING DEVICE FOR A MOTOR VEHICLE

(71) Applicant: VALEO VISION, Bobigny (FR)

(72) Inventors: Benoit DELANDE, Bobigny (FR); Gunnar VIKBERG, Bobigny (FR); Pierre-Louis TASSY, Bobigny (FR)

(73) Assignee: VALEO VISION, Bobigny (FR)

(21) Appl. No.: 19/133,578

(22) PCT Filed: Nov. 28, 2023
(86) PCT No.: PCT/EP2023/083311

§ 371 Date: May 28, 2025

(30) Foreign Application Priority Data
Nov. 29, 2022 (FR) 2212473

(51) Int. Cl. F21S 43/33; F21S 43/14; F21S 43/20; F21S 43/37; F21W 103/10; F21W 103/15; F21W 103/35; F21W 103/40; F21W 103/55

(52) U.S. Cl. CPC F21S 43/33; F21S 43/14; F21S 43/26241; F21S 43/265; F21S 43/37; F21W 2103/10; F21W 2103/15; F21W 2103/35; F21W 2103/40; F21W 2103/55

(57) ABSTRACT

The invention relates to a lighting device with a grid bounding a plurality of light cells arranged in a two-dimensional array. Each light cell being associated with a light source that can be selectively controlled so as to be turned on or turned off, in order to be able to generate a light-based pictogram on the two-dimensional array. The grid bears against a support for the light sources and is held in place by mechanical clamping by means of a closing lens secured to the support. During assembly, the grid is slightly compressed in order to be held in place. For this, the grid is formed of a material that has a Shore hardness of less than 90, so as to be flexible and allow such compression and/or deformation.

### TECHNICAL FIELD

The technical context of the present invention is that of signaling devices for motor vehicles, in order to be able to signal the presence of a motor vehicle or to transmit certain messages to other motor vehicles. More particularly, the invention relates notably to a luminous device for a motor vehicle.

### BACKGROUND OF THE INVENTION

Known from the prior art are luminous devices for motor vehicles, comprising light sources configured to emit light rays, each light source being optically coupled to a light guide so that at least part of the light rays generated by each light source are injected into the associated light guide and form, at an exit face, a matrix array of light cells. Each light cell is thus controlled in such a way as to be able to generate “luminous pixels” making it possible to create numerous luminous functionalities on the motor vehicles. Such luminous functionalities make it possible in particular to indicate to a neighboring motor vehicle one or more pieces of information relating, for example, to a state of the motor vehicle on which the luminous device is mounted, or else to a state of traffic that the neighboring motor vehicle will shortly encounter. By way of example, such luminous devices make it possible to indicate information relating to the state of charge of an electric traction battery, to a breakdown, to a speed and/or to a future trajectory of the motor vehicle.

One known drawback of such luminous devices relates to the optical coupling between two adjacent light cells: such optical coupling leads to light rays from a first light cell propagating in or at a second light cell directly adjacent to the first light cell. Such optical coupling is not desired as it impairs the visibility of the luminous information that is to be displayed by the known luminous devices by changing the luminous intensity of an adjacent light cell, in particular by increasing its luminous intensity or giving the impression that this adjacent light cell is on when it should be off.

In a known manner, the optical coupling between two adjacent light cells is reduced by increasing the spacing between said two adjacent light cells. However, this solution leads to the downgrading of a spatial density of the light cells on the known luminous devices.

Finally, another problem of known luminous devices lies in the perforated mask used to bound the luminous cells. The perforated mask extends between the light sources and an enclosing outer lens of the known luminous devices, located at the level of an exit face for the light rays. In known luminous devices, such a perforated mask is formed of a rigid plastic material. The perforated mask is then fixed securely to a support of the light sources and extends in the direction of the enclosing outer lens. For obvious assembly reasons, and despite all the precautions taken to reduce the dimensions thereof, there remains a minimum clearance between the enclosing outer lens and an upper end of the perforated mask. This minimal clearance means that light rays generated in a first light cell are able to pass into a directly adjacent light cell, thus achieving the undesired optical coupling.

### SUMMARY OF THE INVENTION

It is an objective of the present invention to propose a new luminous device in order to solve the aforementioned problems at least to a large extent, and also to lead to other advantages.

Another object of the invention is to improve the optical isolation between two adjacent light cells by reducing the optical coupling.

Another object of the invention is to reduce the spacing between two adjacent light cells and to increase the density of light cells for such a luminous device.

Another object of the invention is to make such a luminous device easier to assemble.

Another object of the invention is to make curved luminous devices easier to manufacture.

According to a first aspect of the invention, at least one of the aforementioned objectives is achieved with a luminous device for a motor vehicle, the luminous device comprising:
a support;
a plurality of light sources configured to generate light rays, the light sources being secured to the support;
a grid forming a plurality of light cells facing the light sources, each light cell being separated from a directly adjacent light cell, the grid forming a perforated mask perforated at a distal end distal from the light sources;
an enclosing outer lens located facing the light cells and the perforated mask.

In the luminous device according to the invention, the grid is flexible, so that it can be deformed when the perforated mask is mounted between the support and the enclosing outer lens.

In the context of the present invention, the support forms a mechanical support common to all the light sources of the luminous device according to the first aspect of the invention. By way of nonlimiting example, the support may take the form of a plastic sheet, forming for example a printed circuit, or of a printed film. In general, in the context of the invention, the support is stiff or flexible, which is to say deformable in the face of a bending force for example. Furthermore, the support may be of variable geometry. The support may be flat or curved. In general, the support is an electronic board that is electrically connected to the light sources, said light sources being fixed securely to the support, for example by soldering.

In the context of the present invention, the light sources are of the light-emitting diode type, each light source comprising one or more light-emitting diodes. A light-emitting diode means any type of light-emitting diode, such as for example an LED—an acronym for Light-Emitting Diode, an OLED—an acronym for Organic LED, an AMOLED—an acronym for Active-Matrix-Organic LED, or a FOLED—an acronym for Flexible OLED. Advantageously, the light sources are controlled selectively by a control unit which regulates an electrical power supply current supplied to each of said light sources in order to control the emission of light rays thereof. It is thus possible to control the light sources selectively so as to configure them in any configuration between a turned-off configuration and a maximum-lighting configuration.

In the context of the present invention, the grid projects out from the perforated mask towards the support, so as to bound a plurality of spaces facing the light cells. The grid thus forms a two-directional array of light cells facing the light sources, each light cell being associated with at least one light source and each light source being associated with a single light cell. According to the invention, the grid has a flexibility greater than that of the support or of the enclosing outer lens. In other words, the stiffness of the grid is less than the stiffness of the support and/or of the enclosing outer lens. In the context of the invention, the flexibility or the stiffness is evaluated relative to a longitudinal axis extending substantially perpendicular to the support. The grid is therefore configured to allow deformation when it is assembled on the luminous device according to the invention, for example held between the support and the enclosing outer lens. In other words, the grid is configured to allow elastic deformation, notably of the bowing type, when mounted between the enclosing outer lens and the support and in the face of the assembly forces commonly encountered in this technical field. In other words, the bowing allows the grid to be shaped to conform to the geometry of the support and/or of the outer lens. It should be noted that once mounted in the luminous device, the position and shape of the grid are not altered further.

In the context of the present invention, the perforated mask is that part of the grid that is situated facing the light sources and proximate to an exit face of the luminous device. In other words, the perforated mask is situated at some distance from the light sources relative to a direction of propagation of the light rays. Thus, when a user is looking at the luminous device from the outside, the perforated mask forms a cellular structure creating a network of openings-the light cells-bounded by dividers formed by partitions of the grid. The mask and the grid are formed conjointly from the same material so as to form a monolithic entity.

In the context of the present invention, each light cell is bounded laterally by a closed contour obtained at the grid and/or at the perforated mask. The closed contour may have any geometry whatever. Advantageously, it is polygonal in shape, being for example rectangular, square, triangular or hexagonal in shape. Advantageously, the grid and the perforated mask are able to gather to bound light cells that are separated from one another, which means to say that are each laterally bounded with respect to one another. The shape and the dimensions of the light cells may be the same for all of the light cells of the luminous device according to the first aspect of the invention; alternatively, the luminous device may comprise first light cells having a first geometry and/or first dimensions, and second light cells having a second geometry and/or second dimensions; or alternatively still, the light cells may be spread among a plurality of groups, each group comprising at least one light cell, and each group having a geometry and/or dimensions that are different than the geometry and/or than the dimensions of the other groups. When a group comprises a plurality of cells, these may form a connected entity or else a plurality of non-connected entities. Moreover, and particularly advantageously, the lower stiffness of the grid which is to say its greater flexibility-relative to the support and/or to the enclosing outer lens, here makes it possible to ensure better enclosure of the luminous device according to the first aspect of the invention by said enclosing outer lens, making it impossible for a ray of light generated by a given light cell to escape to the directly adjacent light cell.

In the context of the present invention, the light sources are arranged on the support and relative to the grid in such a way that the rays of light generated by said light sources enter the light cells. Thus, each light cell forms an optically through-cavity for-and through which there pass-the rays of light generated by the light sources. Finally, each light source is associated with a single cavity, which is to say with a single light cell. By contrast, a given light cell may be associated with one or with a plurality of light sources.

In the context of the present invention, the enclosing outer lens takes the form of a sheet that is transparent to the rays of light generated by the light sources. The enclosing outer lens enables the luminous device to be closed with respect to the support so that the enclosing outer lens and the support together form a space inside which the light sources and the perforated mask are housed. The enclosing outer lens thus has a certain thickness, measured along its shortest dimension and, in general, perpendicular, notably locally perpendicular, to the surface of the exit outer lens through which the light rays pass. According to a first embodiment variant, the enclosing outer lens holds the grid in position between the enclosing outer lens and the support. Alternatively, the grid may be held in place against the support or against the enclosing outer lens by any fixing means. The enclosing outer lens may be flat or curved. Furthermore, the enclosing outer lens may comprise, at the surface through which the light rays pass, patterns or a metallization that is transparent or partially transparent, notably semi-transparent. In general, the transparency of the outer lens is advantageously such that it transmits more than 50% of the light that reaches it.

In the context of the present invention, the luminous device thus forms a two-dimensional array of adjacent light cells. The luminous device according to the first aspect of the invention is not limited to any shape of two-dimensional array, to any number of rows or columns, or to any shape of light cell. Such a luminous device is thus a matrix luminous device.

Thus, the luminous device according to the first aspect of the invention makes it possible to improve the optical isolation between two adjacent light cells because the grid now provides better shaping, which is to say better matching of shape, and notably of curvature or of dimension measured perpendicular to the support, so as thus to enable a reduction in the optical coupling. Specifically, the mechanical characteristic of relative flexibility of the grid with respect to that of the grids of the luminous devices hitherto known allows better quality fitting, notably proximate to the exit face of said luminous device.

To complement this, it is then easier to manufacture and assemble such a luminous device in so far as control over a dimension of the grid measured in a direction substantially perpendicular to the support is less sensitive now than before because of the novel capacity of the grid to accommodate deformation as it is being fitted.

The luminous device according to the first aspect of the invention advantageously comprises at least one of the following refinements, the technical features forming these refinements being able to be considered alone or in combination:
a Shore A hardness of the grid is less than 90, advantageously between 40 and 90, and preferably between 60 and 80. This advantageous configuration makes it possible to achieve the best compromise between the need for flexibility in order to allow the grid to deform as it is being fitted between the support and the enclosing outer lens, while at the same time ensuring sufficient integrity for stable and robust bounding of the light cells of the luminous device according to the first aspect of the invention;
the grid is formed of a material comprising a silicone and/or an elastomer;
a thickness of the grid is preferably constant at all points, so as to make it easier to manufacture, this grid being obtained for example by molding, preferably compression molding. In the context of the present invention, the thickness of the grid is measured along the shortest dimension of the grid. By way of nonlimiting example, a thickness of the grid may be determined on a plane of section parallel to the support and/or to the enclosing outer lens, and/or in a direction perpendicular, notably locally perpendicular in the region in which the thickness is measured, to a partition that forms the grid;
to complement this, a thickness of the grid, measured along its shortest dimension, is less than or equal to 2 mm, and is preferably between 0 5 mm and 1.5 mm. Specifically, it is particularly advantageous to have a grid that is as thin-walled as possible in order to reduce the spacing between two adjacent light cells while ensuring that the grid remains adequately stable while the luminous device is in use on a motor vehicle. A thickness less than or equal to 1.5 mm, notably at the perforated mask, is particularly advantageous in pursuing this objective;
the grid comprises a plurality of partitions extending between the perforated mask and the support, the partitions projecting out from the support and bounding the light cells. The partitions preferably form opaque walls between two adjacent cells so as to prevent any optical coupling. The partitions may adopt any shape dependent on the overall configuration of the luminous device according to the invention, but also dependent on the shape of the light cells that are to be formed. In a transverse plane extending between the support and the enclosing outer lens, the partitions may extend in a flat or curved manner. In the context of the present invention, a partition is opaque when it prevents a ray of light from being transmitted through said partition. In other words, a partition is opaque if a ray of light is not able to pass to the other side of said partition. The opacity feature is obtained by matching a sufficient thickness with a type of material that is solid and optically absorbent or reflective with respect to the rays of light generated by the light sources. Thus, for the thicknesses proposed in the present invention, the partitions bounding each light cell of the grid enable said partitions to be rendered opaque to said rays of light;
the grid is monolithic. What is meant by monolithic is that the partitions that make up the grid—and in general terms the grid in its entirety—cannot be separated from one another without adversely affecting all or part of their integrity. The grid thus forms an entity qualified as monobloc or monolithic corresponding to one same single continuous component, made as a single piece and obtained during the one same manufacturing process. By way of nonlimiting example, the perforated mask and/or the grid are produced by molding;
the luminous device comprises a diffusing film located facing the light sources, the partitions bearing against the diffusing film at a distal end distal from the support. In the context of the invention, the diffusing film is configured to deflect the incident rays of light in a plurality of directions so as to render uniform a luminous flux carried by said rays of light generated by the light sources of the device according to the invention. In general, the diffusing effect of the diffusing film may be obtained by texturing, notably by graining at least one of the faces, notably both faces, of said diffusing film, and/or by manufacturing the diffusing film from a material that is itself diffusing, for example cloudy. By way of nonlimiting example, the diffusing film comprises at least one frosted face set facing the light sources. In instances in which the frosted film has just one single frosted face, this face is then preferably the one situated on the same side as the exit face of the luminous device according to the first aspect of the invention, namely the one situated on the opposite side from the grid and the support. The diffusing film may be formed from a material comprising glass and/or plastic. Thus, a residual clearance between the diffusing film and the grid measured at the distal end of said grid distal from the support is zero. As a preference, a height of the partitions measured between the support and the distal ends is, before the enclosing outer lens is fitted, greater than or equal to a distance between a face of the enclosing outer lens that is situated facing the support and said support when the enclosing outer lens is fitted on the support. In other words, when the luminous device according to the first aspect of the invention is assembled, the grid is compressed and sandwiched between the support and the enclosing outer lens;
according to an advantageous alternative of the invention, the enclosing outer lens comprises the diffusing film. In other words, the diffusing film and the enclosing outer lens form just one single component. The diffusing film is therefore fixed securely to the support by any known means, notably by screw-fastening. Alternatively, the diffusing film may be overmolded on the enclosing outer lens, or the enclosing outer lens may directly form the diffusing film, preferably on its exit face;
at the distal end bearing against the diffusing film, a width of the perforated mask separating two adjacent light cells is less than or equal to 1 mm, preferably less than or equal to 0.6 mm, preferably equal to 0.5 mm. This advantageous configuration makes it possible to have a grid with the thinnest possible walls and to increase the density of light cells. It also makes it possible to create light cells of smaller dimensions. The width of the perforated mask separating the two adjacent cells is measured at an end of the grid that is distal from the support. The width of the perforated mask is measured between two adjacent light cells and at the diffusing film or at their end that is distal from the support, relative to an axis perpendicular to said support. In other words again, the width of the perforated mask is measured at the grid, in a plane parallel to the support and farthest from said support. A width between two light cells of the luminous device according to the invention is preferably uniform across the entirety of the perforated mask;
at a lower end of the grid located against the support, the grid has a flange which extends into at least a portion of the light cells. In other words, the partitions forming the grid and bounding the light cells have a transverse profile in the form of an inverted L or of an inverted T, the flange of each partition extending against the support so as to increase the area of contact between the grid and said support. This configuration is particularly advantageous because, working in harmony with the choice of a lower stiffness, it is then possible for the grid no longer to be attached securely to the support-as in the known luminous devices-but simply for the grid to be placed in contact with and bearing against the support. The grid is therefore supported, but without damaging the support or the electrical tracks that may extend along said support for electrically powering the light sources. Thus, the luminous device according to the first aspect of the invention is simpler to manufacture and to implement;
a height of the flanges, measured in a direction substantially perpendicular to the support, is preferably less than a height of the light sources measured between the support and an emission face of said light sources. In other words, a height of the flanges is such that, for a given light cell, the emission face of the associated light source or sources is situated beyond said flanges, relative to the support. More particularly, for each light cell, the emission face of the light source housed in said light cell is situated above the flange of the partitions bounding said light cell. This advantageous configuration makes it possible to strengthen the optical isolation of each light cell and avoid optical coupling between two adjacent light cells. In the context of the present invention, the emission face of the light sources is the face of a given light source through which the rays of light generated by said light source pass and reach the corresponding light cell;
the partitions of two adjacent light cells display, in a transverse plane perpendicular to the support, a V-shape the point of which V lies toward the enclosing outer lens, at an end of the grid that is distal from the light sources and from the support. In other words, two adjacent partitions bounding two adjacent light cells are connected to one another at the distal end of the grid that is distal from the support. This advantageous configuration makes it possible to create hinging between two adjacent light cells, thus allowing the grid to be deformed elastically when it is to be manipulated in order to fit it in place for example, or in order to access the light sources at a later point in time. In harmony with the flexible nature of the grid, it is thus possible to facilitate the operations of assembling and of repairing the luminous device according to the invention.

Further, in harmony with the flanges that give the grid greater stiffness at said flanges compared with the stiffness of the grid considered at the perforated mask, it is now possible for the grid easily to be given a curved configuration while at the same time making it easier to cause it to bear against the support. Finally, this configuration is particularly advantageous for making it possible, during these temporary deformations at the time of setting or permanent deformations in the case of the luminous device according to the invention having a curved shape, for the light cells formed by the grid to hold their shape or at least become deformed to a lesser extent;
in order to limit or even prevent optical coupling between two adjacent light cells, an interior surface of the grid situated at the light cells and on the same side as the light sources is white. In other words, the partitions of the grid bounding a light cell are, on the same side as the light cell, white so as to reflect the rays of light generated by the associated light source(s) and that reach said partition;
in order to limit or even prevent optical coupling between two adjacent light cells, an exterior surface of the grid situated between two adjacent light cells is advantageously, though nonlimitingly, black. In other words, the partitions of the grid bounding a light cell are, on the opposite side from the light cell, black so as to absorb the rays of light generated by the associated light source(s) and that reach said partition. More generally, the optical coupling between two adjacent light cells can be reduced or even nullified by making the partitions opaque. The choice of a given color may contribute to obtaining the desired opacity;
more generally, the grid is formed from a material that is opaque to the rays of light generated by the light sources. More particularly, the partitions that form the grid and bound the light sources are opaque. The opacity of the partitions that form the grid is obtained by choosing a sufficient thickness and/or a type of material that is optically absorbent or reflective with respect to the rays of light generated by the light sources. Thus, for the thicknesses and/or the materials and/or the colors proposed in the present invention, the partitions bounding each light cell of the grid enable said partitions to be rendered opaque to said rays of light;
the support, the grid, the enclosing outer lens and, where applicable, the diffusing film, have a radius of curvature such that the light cells are distributed over a curved surface. In other words, the support, the grid and the enclosing outer lens and, where applicable, the diffusing film, all have a convex geometry or a concave geometry. Specifically, the use of a grid having a lower stiffness in comparison with the grids of the known luminous devices makes it possible, by extension, to propose luminous devices with more complex geometries, while still making them easier to design and to assemble;
the enclosing outer lens is secured to the support so as to form, with said support, a space inside which the light sources, the perforated mask and the grid and, where applicable, the diffusing film, are housed. According to a first embodiment variant, the enclosing outer lens is fixed securely to the support in a direct manner. By way of nonlimiting example, the enclosing outer lens comprises lateral walls that extend toward the support and bear against said support. According to a second embodiment variant, the enclosing outer lens is fixed securely to the support in an indirect manner. By way of nonlimiting example, the luminous device comprises a housing that houses the support, the light sources, the mask and the grid and, where applicable, the diffusing film, while the enclosing outer lens is then fixed securely to the housing in order to close the housing. In either one of the embodiment variants, the grid and the perforated mask are sandwiched between the enclosing outer lens and the support, thus enabling the grid to be held in place by clamping and making the luminous device according to the invention easier to implement;
the housing forms a space configured to house at least the support, the light sources, the perforated mask and the grid. To this end, the housing advantageously comprises peripheral walls able to bound the space and protect the support, the light sources, the perforated mask and the grid that are housed inside it. According to a first alternative, the housing is rigid. What is meant by rigid in the field of use of the invention, namely that of lighting and/or signaling devices intended to be mounted on a motor vehicle, is then that the housing is not configured to be able to be deformed as it is being installed, notably in the face of a bending force with respect to the support of the light sources. The support is therefore preferably made of plastic or of metal. In a second alternative, the housing is flexible and deformable so that as it is being fitted, the housing is configured to be able to be deformed notably in the face of a bending force with respect to the support of the light sources. The support is then preferably formed from a material comprising a soft plastic and/or an elastomer and/or a silicone.

A second aspect of the invention proposes a motor vehicle signaling device comprising a luminous device according to the first aspect of the invention or according to any of the refinements thereof.

Advantageously, the signaling device according to the second aspect of the invention is configured to be mounted on a rear face of a vehicle and/or a front face of a vehicle and/or on one or more pillars of a vehicle, and/or inside a vehicle interior, notably on an instrument panel and/or on one or more door(s). What is meant by vehicle is notably a motor vehicle.

Advantageously, the signaling device according to the second aspect of the invention is of the turn indicator or brake light or nighttime position light or daytime running lamp (DRL) or fog light or side marker lamp type.

Various embodiments of the invention, incorporating in all of their possible combinations the various optional features described here, are provided.

### BRIEF DESCRIPTION OF DRAWINGS

Other features and advantages of the invention will become more clearly apparent on the one hand from the following description, and on the other hand from a plurality of exemplary embodiments that are given non-limitingly and by way of indication with reference to the appended schematic drawings, in which:

FIG. 1 illustrates a schematic view in cross section of a first embodiment of the luminous device according to the first aspect of the invention;

FIG. 2 illustrates a sectioned perspective view of a second embodiment of the luminous device according to the first aspect of the invention;

FIG. 3 illustrates a perspective view of the luminous device illustrated in FIG. 2. In FIG. 3, the enclosing outer lens is not visible, and the grid is illustrated in its natural configuration prior to being shaped to conform to the curvature of the support depicted in FIG. 3; and

FIG. 4 illustrates a motor vehicle comprising a luminous device according to the first aspect of the invention.

### DETAILED DESCRIPTION OF THE INVENTION

Of course, the features, variants and different embodiments of the invention may be combined with one another, in various combinations, provided that they are not mutually exclusive or incompatible. It will be possible, in particular, to imagine variants of the invention that comprise only a selection of the features described below, in isolation from the other features described, if this selection of features is sufficient to confer a technical advantage or to distinguish the invention from the prior art.

In particular, all the variants and all the embodiments described are combinable with one another if there is nothing preventing this combination from a technical perspective.

In the figures, elements that are common to multiple figures retain the same reference.

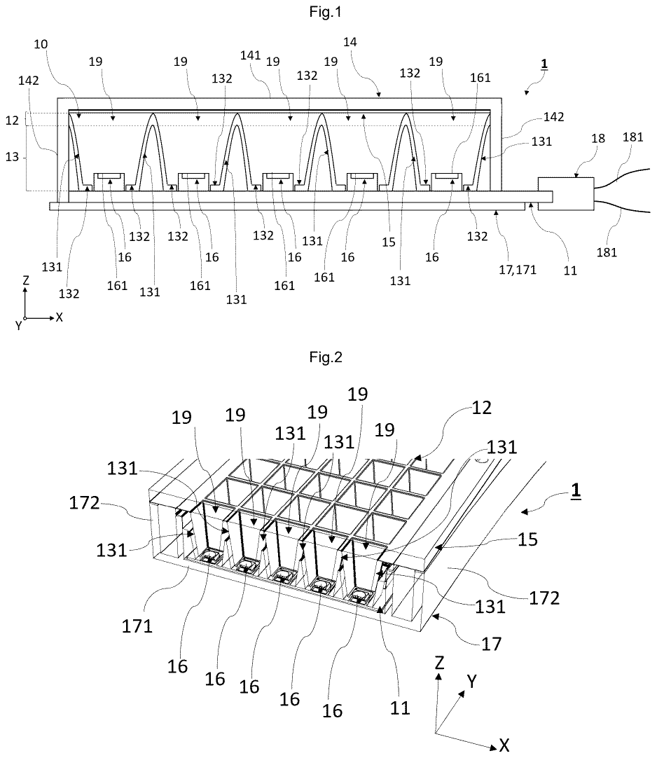

Reference is made to FIGS. 1 to 3 which illustrate a luminous device 1 enabling the display of one or more pixelated pictograms so as to display and transmit information to an observer situated at some distance from the luminous device 1.

According to the invention, such a luminous device 1 comprises:
a support 11;
a plurality of light sources 16 configured to generate light rays, the light sources 16 being secured to the support 11;
a grid 13 forming a plurality of light cells 19 facing the light sources 16, each light cell 19 being separated from a directly adjacent light cell 19, the grid 13 forming a perforated mask 12 perforated at a distal end distal from the light sources 16 ;-an enclosing outer lens 14 located facing the light cells 19 and the perforated mask 12. In the examples illustrated, the enclosing outer lens 14 holds the grid 13 in position between the enclosing outer lens 14 and the support 11.

In the luminous device 1 according to the invention, the grid 13 is flexible, so that it can be deformed when the perforated mask is mounted between the support 11 and the enclosing outer lens 14.

In the figures described hereinafter, a longitudinal axis X, a lateral axis and a vertical axis Z are defined relative to the luminous device 1. More particularly, the transverse axis Y and the longitudinal axis X together form a plane in which the light sources 16 are distributed. Such a plane is formed overall by the support 11 that supports the light sources 16. The vertical axis Z extends as if in an overall direction of propagation of the rays of light generated by the light sources 16 and toward the enclosing outer lens 14. In general, the vertical axis Z is substantially perpendicular to the support 11.

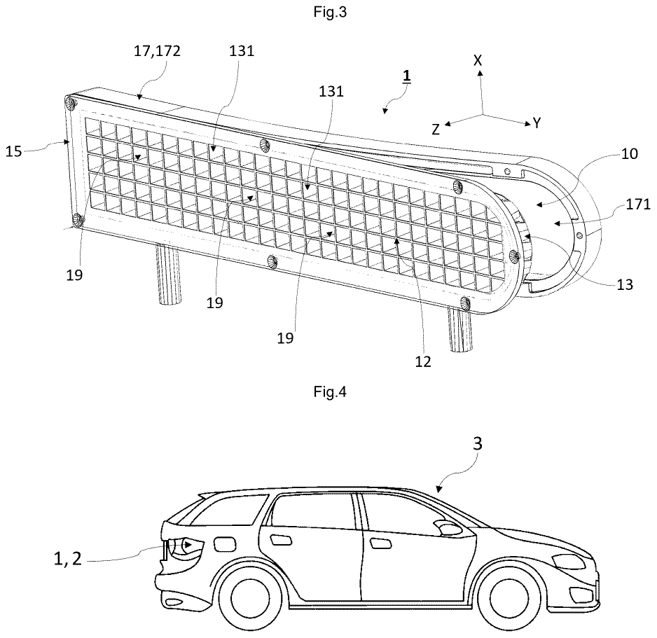

The support 11 is first and foremost a mechanical support 11 for the light sources 16. It is also configured to be able to carry electrical signals for the selective control and the supply of electrical power required for the operation of the light sources 16. Thus, the support 11 is preferably of the flexible or rigid electronic board type, namely one that is respectively deformable or non-deformable when mounted in the luminous device 1. Thus, in the embodiment illustrated in FIG. 1, the support 11 is flat. In the embodiment illustrated in FIGS. 2 and 3, the support 11 is curved once it has been mounted on the luminous device 1.

The support 11 enables the light sources 16 to be attached securely at predetermined locations such that each light source 16 is associated with one, and only one, light cell 19. Thus, in the context of the invention, control over the positions at which the light sources 16 are installed on the support 11, relative to the position and dimensions of the grid 13 and of the associated perforated mask 12 is important.

At an end of the grid 13 that is distal from the support 11, the perforated mask 12 defines a collection of cross-arms that separate two adjacent light cells 19 so as to form a two-dimensional array of light cells 19 of which the local and selective state of lighting will make it possible to generate the luminous information to be displayed on the luminous device 1.

In the embodiments visible in the FIGURES, the perforated mask 12 and the grid 13 are formed conjointly from the same material, so as to form a single monobloc entity.

Moreover, and particularly advantageously, the grid 13 is formed from a material having a high elastic modulus so as to allow the grid 13 to deform when it is mounted on the luminous device 1.

Specifically for example, when the luminous device 1 is being assembled, the grid 13 is first of all applied to the support 11 so as to isolate each light source 16 in a single light cell 19 formed by the grid 13, and then compressed-directly or indirectly-between the support 11 and the enclosing outer lens 14 so as to hold said grid 13 in place and sandwiched against the support 11. This advantageous configuration thus makes it possible to avoid the grid 13 and the perforated mask 12 moving while the luminous device 1 is in use.

Alternatively, the grid could be shaped and held against the support or against the grid by any fixing means.

Thus, the invention differs from the known grids 13 in that the latter are formed from a rigid plastic material, the mechanical properties of which do not permit deformation upon mounting on the luminous device 1 according to the invention. Thus, the known grids 13 entail achieving an accurate fit between the grid 13, the support 11 and the enclosing outer lens 14 in order to ensure that the luminous device 1 is adequately enclosed. Furthermore, it is also necessary for the known grids 13 to be fixed to their support 11 in order to prevent them from moving during use of the known luminous devices. Such a configuration was hitherto particularly troublesome and expensive because it also added complexity to the design of the electronic board in order to prevent the regions of contact of the grid 13 on the support 11 coinciding with the electrical tracks supplying power to the light sources 16.

By contrast, the use of a grid 13 that is now flexible makes it possible to overcome all these deficiencies: compressing the grid 13 between the support 11 and the enclosing outer lens 14 provides a firm hold without the need to design a physical fixing on said support 11, and the flexible nature of the grid 13 ensures that any electrical tracks that may be situated in the region of contact of the grid 13 with the support 11 do not become damaged. The support 11 of the luminous device 1 according to the invention can thus be conceived of and designed more simply.

Particularly advantageously, the expected flexible nature of the grid 13 is obtained by using material of which the Shore hardness is between 60 and 80 and in any event less than 90. A material having a Shore hardness of the order of 40 or 50 could also be used in the context of the present invention.

To complement this, the grid 13 is preferably formed of a material comprising silicone or elastomer.

As mentioned previously, the grid 13 makes it possible to design, at a distal end distal from the support 11, a collection of cross-arms which bound two directly adjacent light cells 19. This collection of cross-arms thus forms the perforated mask 12 of the grid 13 that is visible from the outside. Between the perforated mask 12 and the support 11, the grid 13 extends these cross-arms via a collection of partitions 131 that project from the perforated mask 12 toward said support 11. Each partition 131 thus forms a wall that is opaque to the rays of light generated by the light sources, each partition 131 laterally and longitudinally bounding a light cell 19.

The partitions 131 of the grid 13 may have any shape and any dimension. However, for the sake of uniformity, the dimensions of a light cell 19, measured in a plane formed by the longitudinal axis X and the transverse axis Y is constant for the entirety of the luminous device 1. As a result, the geometry of the light cells 19 considered in the plane formed by the longitudinal axis X and the transverse axis Y is constant for the entirety of the luminous device 1.

In the embodiment illustrated in FIGS. 2 and 3, the light cells 19 bounded by the grid 13 have a polygonal, and more particularly rectangular or even square, shape.

Along the vertical axis Z, the partitions 131 bounding the light cells 19 may be straight or curved, depending on the effects desired.

Furthermore, in the plane formed by the vertical axis Z and the longitudinal axis X or the transverse axis Y, the partitions 131 of two adjacent light cells 19 have a V-shape, the point of which V lies toward the enclosing outer lens 14, at an end of the grid 13 that is distal from the light sources 16 and from the support 11: two adjacent partitions 131 bounding two adjacent light cells 19 are connected to one another at the distal end of the grid 13 that is distal from the support 11.

The partitions 131 forming the grid have a constant thickness. To achieve this, the grid 13 and the perforated mask 12 are preferably obtained by molding.

In order to encourage the grid 13 to press against the support 11, the grid 13 has a flange 132 situated at a lower end of the partitions 131 situated proximate to said support 11. The flange 132 thus forms a region via which the grid 13 bears against the support 11. More particularly, each partition 131 bounding a light cell 19 has such a flange 132.

The flange 132 thus forms a protrusion that projects from the partition 131 relative to the transverse axis Y or to the longitudinal axis X. Advantageously, as visible in FIGS. 1 and 2, the flange 132 extends toward the light cell 19 so as to form a peripheral surround to the light source 16 associated with said light cell 19.

Furthermore, as visible in FIGS. 1 and 2, the light source 16 is situated above each flange 132 of the associated light cell 19, relative to the vertical axis Z. In other words, the flanges 132 defining the region of contact of the grid 13 against the support 11 form a peripheral surround to each light source 16 and make it possible to reduce or even prevent the optical coupling between two adjacent light cells 19 at the support 11. Specifically, because the light source 16 is now situated beyond the flange 132 relative to the support 11, the rays of light generated by an emission face 161 of the light source 16 now have to extend toward the exit face 141 and not toward the support 11.

At the exit face 141, the luminous device 1 comprises a diffusing film 15 able to diffuse the rays of light generated by each light source 16 in the turned-on light cells 19 of the luminous device 1. The diffusing film 15 thus allows the incident rays of light to be deflected in a plurality of different directions, thus improving the visual rendering of the luminous device 1 when in use and also making it possible to reduce the apparent distance between two adjacent light cells 19.

Particularly advantageously, the use of a flexible grid 13 associated with the diffusing film 15 enables the perforated mask 12 to be compressed, at the diffusing film 15 and/or at the exit face 141, against said diffusing film 15 and/or against said exit face 141. This configuration thus makes it possible to reduce or even prevent any optical coupling between two adjacent light cells 19. In other words, when the luminous device 1 according to the invention is assembled, there is zero clearance between the perforated mask 12 and the diffusing film 15 and/or the exit face 141. It is thus possible to employ faster and less costly manufacturing processes for manufacturing a perforated mask 12 and a flexible grid 13 having a dimension along the vertical axis Z that is equal to or slightly greater than the distance separating the diffusing film 15 or the exit face 141 from the support 11. This configuration makes it possible to ensure, for a lower cost, that the grid 13 is compressed as it is being installed, thereby reducing or even preventing any optical coupling in the vicinity of the exit face 141 of the luminous device 1.

In the luminous device 1 according to the invention, the enclosing outer lens 14 is secured to the support 11 and holds the grid 13 in place against the support 11.

In the exemplary embodiment illustrated in FIG. 1, the enclosing outer lens 14 is fixed securely and directly to the support 11, the enclosing outer lens 14 comprising the exit face 141 and lateral faces 142 that collaborate with the support 11 so that together they form a space 10 to house the grid 13, the light sources 16 and the diffusing film 15, where present.

In the exemplary embodiment illustrated in FIG. 1, the diffusing film 15 is mounted against the distal end of the grid 13 that is distal from the support 11, at the perforated mask 12. The diffusing film 15 is then held in place against the grid 13 by the enclosing outer lens 14.

In the exemplary embodiment illustrated in FIGS. 2 and 3, the luminous device 1 comprises a housing 17 comprising a back wall 171 and lateral walls 172 that together delimit a space 10 housing the grid 13, the light sources 16 and the diffusing film 15. The diffusing film 15 here acts as an enclosing outer lens 14 and also forms the exit face 141 of the luminous device 1. The diffusing film 15 is fixed securely and directly to the housing 17 by screw-fastening to the lateral walls 172 of the housing 17.

Of course, in order for it to function, the luminous device 1 comprises an electrical-connection interface 18 able to supply electrical power to the light sources 16 via electrical connectors 181.

A motor vehicle 3 comprising a signaling device 2 comprising a luminous device 1 as described hereinabove is described with reference to FIG. 4. The signaling device 2 is preferably of the rear turn indicator or rear brake light or rear nighttime position light or rear fog light type.

In summary, the invention relates to a luminous device 1 comprising a grid 13 bounding a plurality of light cells 19 arranged in a two-dimensional array. Each light cell 19 is associated with a light source 16 that can be selectively controlled to be turned on or turned off in order to be able to generate a light-based pictogram on the two-dimensional array. The grid 13 bears against a support 11 for the light sources 16 and is held in place by mechanical clamping by means of an enclosing outer lens 14 secured to the support 11. During such assembly, the grid 13 is slightly compressed in order to be held in place. For this, the grid 13 is formed of a material having a Shore hardness of less than 90, so as to be flexible and allow such compression and/or deformation.

Of course, the invention is not limited to the examples which have just been described, and many modifications may be made to these examples without departing from the scope of the invention. In particular, the various features, forms, variants and embodiments of the invention may be combined with one another, in various combinations, as long as they are not mutually incompatible or exclusive. In particular, all the variants and embodiments described above are combinable with one another.

What is claimed is:

1. A luminous module for a motor vehicle, the luminous module comprising:
a support;
a plurality of light sources configured to generate light rays, the light sources being secured to the support;
a grid forming a plurality of light cells facing the light sources, each light cell being separated from a directly adjacent light cell, the grid forming a perforated mask perforated at a distal end distal from the light sources;
an enclosing outer lens located facing the light cells and the perforated mask;
wherein the grid is flexible so as to be able to be deformed when the perforated mask is mounted between the support and the enclosing outer lens.

2. The luminous device as claimed in claim 1, wherein a Shore A hardness of the grid is less than 90.

3. The luminous device as claimed in claim 1, wherein the grid is formed of a material including a silicone and/or an elastomer.

4. The luminous device as claimed in claim 1, wherein a thickness of the grid, measured along the grid's smallest dimension, is less than or equal to 2 mm.

5. The luminous device as claimed in claim 1, wherein the grid includes a plurality of partitions extending between the perforated mask and the support, the partitions projecting out from the support and bounding the light cells.

6. The luminous device as claimed in claim 5, wherein the luminous device includes a diffusing film located facing the light sources, the partitions bearing against the diffusing film at a distal end distal from the support.

7. The luminous device as claimed in claim 6, wherein, at the partitions distal end bearing against the diffusing film, a width of the perforated mask separating two adjacent light cells is less than or equal to 1 mm.

8. The luminous device as claimed in claim 1, wherein at a lower end of the grid located against the support, the grid has a flange which extends into at least a portion of the light cells.

9. The luminous device as claimed in claim 1, wherein the grid is formed of a material opaque to the light rays generated by the light sources.

10. The luminous device as claimed in claim 1, wherein a Shore A hardness of the grid is between 60 and 80.

11. The luminous device as claimed in claim 1, wherein a thickness of the grid, measured along the grid's smallest dimension, is between 0.5 mm and 1.5 mm.
